(19) United States
(12) Patent Application Publication
(10) Pub. No.: US 2010/0234526 A1
(43) Pub. Date: Sep. 16, 2010

(54) COATING COMPOSITIONS HAVING IMPROVED PROPERTIES

(75) Inventors: Michael Kutschera, Chieming (DE); Lydie Tuchbreiter, Speyer (DE); Nick Gruber, Mannheim (DE); Ruediger Stark, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/744,395

(22) PCT Filed: Dec. 11, 2008
(86) PCT No.: PCT/EP2008/067320

§ 371 Date: May 24, 2010

(30) Foreign Application Priority Data
Dec. 21, 2007 (EP) 07123911.5

(51) Int. Cl. C08L 75/00

(52) U.S. Cl. 524/589

(57) ABSTRACT

The present invention relates to coating compositions which produce coatings of high hardness and simultaneously high flexibility and/or high scratch resistance.

The present invention relates to coating compositions which produce coatings of high hardness and simultaneously high flexibility and/or high scratch resistance.

In coatings, flexibility and hardness are typically mutually exclusive features. Hard coatings are generally brittle, i.e., lack flexibility, and flexible coatings are usually relatively soft. For radiation-curable coatings, an attempt has been made recently to determine—for (meth)acrylates, which typically produce hard coatings—the factors which make the coatings flexible; see J. Weikard, W. Fischer, E. Lühmann, D. Rappen, RadTech USA, e/5, 2004, Technical Proceedings on CD, 2004.

A disadvantage is that the investigations there relate solely to radiation-curable (meth)acrylates as coating compositions, whose cure behavior is different from that of other coating compositions; such as two-component coating compositions, for example.

The object of the present invention was to develop coating compositions which produce high hardness with simultaneously high flexibility and/or high scratch resistance in the coatings obtained from them.

This object has been achieved by means of a coating composition comprising at least one crosslinker (A), which carries a multiplicity of functional groups FG, and at least one binder (B), which carries groups which are reactive toward the functional groups FG of the crosslinker (A), the functional groups FG being isocyanate groups (—NCO), the crosslinker being constructed of
at least one spacer which is substantially free from functional groups FG, and
at least two head groups arranged terminally on the spacer,
   the spacer
being substantially acyclic and
being substantially constructed of at least 50 atoms and groups of atoms which are joined to one another by single bonds and are in each case independently of one another selected from the group consisting of —CH₂—, —CHR³—, —CR³R⁴—, —C(═O)—, —O—, —NH—, and —NR³—,
   and the head groups
each carrying at least two functional groups FG, the density of functional groups FG in the crosslinker (A) being at least 2 mol/kg.

The admixing of inventive crosslinkers of this kind into coating compositions simultaneously increases hardness and flexibility and/or high scratch resistance in the coatings obtained from them.

The coating compositions of the invention are crosslinker (A)-binder (B) combinations, in other words two-component coating compositions. In these compositions the crosslinker (A) contains functional groups (FG) which are reactive toward the groups of the binder (B).

In accordance with the invention the functional groups (FG) of the crosslinker (A) are isocyanate groups (—NCO).

The binder component (B) has groups which are complementary to the functional groups (FG) of the binder (A).

These complementary groups of the binder (A) are preferably hydroxyl (—OH), primary amino (—NH₂) and/or secondary amino (—NHR¹) groups, preferably hydroxyl groups.

Therein, R¹ is C₁ to C₁₈ alkyl, C₆ to C₁₂ aryl or C₅ to C₁₂ cycloalkyl, preferably C₁ to C₁₈ alkyl, more preferably C₁ to C₄ alkyl, it being possible for these to be substituted in each case, if desired, by aryl, alkyl, aryloxy, alkyloxy, heteroatoms and/or heterocycles.

By C₁ to C₄ alkyl is meant here methyl, ethyl, isopropyl, n-propyl, n-butyl, isobutyl, sec-butyl and tert-butyl, preferably methyl, ethyl, isopropyl, n-propyl, n-butyl and tert-butyl, more preferably methyl, ethyl, n-butyl and tert-butyl, very preferably methyl, ethyl and n-butyl, and more particularly methyl.

In accordance with the invention the crosslinker (A) is constructed of a spacer and at least two head groups which are arranged terminally on the spacer and each carry at least two functional groups FG. The number of functional groups FG per head group may be preferably up to 10, more preferably up to 8, very preferably up to 6, and more particularly up to 5.

The term “head group” in the context of the present invention is defined as follows: the terminally located constituents of the crosslinker (A) that do not belong to the spacer and that carry the functional groups FG.

The number of head groups may be on average preferably up to 10, more preferably up to 8, very preferably up to 5, more particularly up to 4, and especially up to 3. In one particular embodiment the number of head groups per crosslinker is precisely 2.

The functionality of the crosslinkers may be calculated from the number of head groups multiplied by the number of functional groups per head group, and therefore corresponds to the total number of functional groups in the crosslinker molecule.

The total density of functional groups FG in the crosslinker (A) is at least 2.0, preferably at least 2.5 mol/kg, and may with particular preference be from 2.5 mol/kg to 8 mol/kg, very preferably from 3 to 6 mol/kg.

A simplified expression of the present invention is to say that number and density of functional groups (FG) in the crosslinker (A) influence the hardness of the resultant coating, whereas nature and length of the spacer influence the flexibility of the resultant coating. By playing on these variables within the bounds of this invention, the skilled worker is able to adjust the properties of the resulting coating.

The term “spacer” in the context of the present invention is defined as follows: that region inside the crosslinker (A) which
is substantially acyclic, i.e., at least 80% of the atoms and groups of atoms that form the spacer are constituents of acyclic structures, and
is substantially constructed of at least 50 and up to 2000 atoms and groups of atoms that are connected to one another by single bonds and are selected in each case independently of one another from the group consisting of —CH₂—, —CHR³—, -CR³R⁴—, —C(═O)—, —O—, —NH—, and —NR³—, i.e., not more than 10 bonds of the spacer are multiple bonds and/or part of a ring system.

The spacer is substantially free from functional groups FG, which means that not more than 10% of all the functional groups FG present in the crosslinker are attached to the spacer, preferably not more than 5%, and more preferably no functional groups FG are attached to the spacer.

In accordance with the invention the spacer is substantially acyclic, which in the context of the present invention means that at least 80%, preferably at least 85%, more preferably at least 90%, very preferably at least 95%, and more particularly 100% of the atoms and groups of atoms that form the spacer are constituents of acyclic structures.

The spacer is substantially constructed of at least 50, preferably at least 75, more preferably at least 100, and very preferably at least 150, and up to 2000, preferably up to 1500, more preferably up to 1000, and very preferably up to 750 atoms and groups of atoms that are connected to one another substantially by single bonds and are selected in each case independently of one another from the group consisting of —CH₂—, —CHR³—, —CR³R⁴—, —C(═O)—, —O—, —NH—, and —NR³—, preferably selected from the group consisting of —CH₂—, —CHR³—, —CR³R⁴—, —C(═O)—, and —O—, more preferably selected from the group consisting of —CH₂—, —CHR³—, —C(═O)—, and —O—, very preferably selected from the group consisting of —CH₂—, —C(═O)—, and —O—, the species in question being more particularly —CH₂— and optionally —O—.

The designation “connected to one another substantially by single bonds” means that not more than 10% of the bonds of the spacer are multiple bonds and/or part of a ring system, preferably not more than 8%, more preferably not more than 5%, very preferably not more than 3%, and more particularly none.

R³ and R⁴ are independently of one another C₁ to C₁₈ alkyl, C₆ to C₁₂ aryl or C₅ to C₁₂ cycloalkyl, preferably C₁ to C₁₈ alkyl, and more preferably C₁ to C₄ alkyl.

Spacer and head groups are connected chemically to one another. For differentiation of the definitions between spacer and head groups it should be borne in mind that the first non-acyclic atom after the spacer is already part of the head group.

The way in which head group and spacer are connected to one another plays only a minor part in accordance with the invention. Generally speaking, spacer and head group carry complementary, inter-reactive groups, preferably a group FG, which is located preferably on the head group, and a complementary group, which is located preferably on the spacer, which are reacted with one another, with formation of a chemical bond.

In one preferred embodiment of the present invention the basic structure of the spacer is selected from the group consisting of polyethers, polyesters, hydrocarbons, and polyurethane polyols, preferably selected from the group consisting of polyethers, polyesters, and polyurethane polyoles, more preferably selected from the group consisting of polyethers and polyesters, and very preferably a polyether.

Examples of suitable spacers are polyetherols, which are prepared by addition of ethylene oxide, propylene oxide or butylene oxide to H-active components. Also suitable are polycondensates of butanediol. The functionality of the polyetherols corresponds in general to the number of head groups to be attached to the spacer.

Conceivable H-active components are ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,4-butanediol, 1,5-pentanediol, neopentylglycol, neopentylglycol hydroxypivalate, 2-ethyl-1,3-propanediol, 2-methyl-1,3-propanediol, 2-butyl-2-ethyl-1,3-propanediol, 1,6-hexanediol, 2-methyl-1,5-pentanediol, 2-ethyl-1,4-butanediol, 2-ethyl-1,3-hexanediol, 2,4-diethyloctane-1,3-diol, 2,2-bis(4-hydroxycyclohexyl)propane, 1,1-, 1,2-, 1,3-, and 1,4-bis(hydroxymethyl)cyclohexane, 1,2-, 1,3- or 1,4-cyclohexanediol, glycerol, trimethylolethane, trimethylolpropane, trimethylolbutane, pentaerythritol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, isomalt, which component is then reacted with an alkylene oxide, preferably ethylene oxide, propylene oxide or butylene oxide, more preferably ethylene oxide or propylene oxide, and very preferably ethylene oxide, until the desired length is reached, i.e., until the desired number of atoms and groups of atoms is obtained.

The polyether preferably comprises polyTHF having a molar weight of between 700 and 4500, preferably 800 to 2000, poly-1,3-propanediol or polypropylene glycol having a molar weight of between 134 and 2000, or polyethylene glycol having a molar weight of between 238 and 2000, more preferably a polyTHF.

Additionally conceivable spacers are polyesterols, of the kind obtainable by condensing polycarboxylic acids, especially dicarboxylic acids, with polyols, especially diols. In order to ensure a polyester polyol functionality that is appropriate for polymerization, use is also made in part of triols, tetrols, etc., and triacids, etc.

Polyester polyols are known for example from Ullmanns Encyklopädie der technischen Chemie, 4th edition, volume 19, pp. 62 to 65. It is preferred to use polyester polyols which are obtained by reacting dihydric alcohols with dibasic carboxylic acids. In lieu of the free polycarboxylic acids it is also possible to use the corresponding polycarboxylic anhydrides or corresponding polycarboxylic esters of lower alcohols or mixtures thereof to prepare the polyester polyols. The polycarboxylic acids may be aliphatic, cycloaliphatic, aromatic or heterocyclic and may if appropriate be substituted, by halogen atoms for example, and/or unsaturated. Examples thereof that may be mentioned include the following:

Oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, C₁-C₄ alkyl esters for example, preferably methyl, ethyl or n-butyl esters, of the stated acids are employed. Aliphatic carboxylic acids and derivatives thereof are particularly preferred among these. Preference is given to dicarboxylic acids of the general formula HOOC—(CH₂)_{y}—COOH, where y is a number from 1 to 20, preferably an even number from 2 to 20, and more preferably succinic acid, adipic acid, sebacic acid, and dodecanedicarboxylic acid.

Suitable polyhydric alcohols for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, PolyTHF having a molar mass of between 162 and 4500, preferably 250 to 2000, poly-1,3-propanediol having a molar mass between 134 and 1178, poly-1,2-propanediol having a molar mass between 134 and 898, polyethylene glycol having a molar mass between 106 and 458, neopentyl glycol, neopentyl glycol hydroxypivalate, 2-ethyl-1,3-propanediol, 2-methyl-1,3-propanediol, 2,2-bis(4-hydroxycyclohexyl)propane, 1,1-, 1,2-, 1,3- and 1,4-cyclohexanedimethanol, 1,2-, 1,3- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which optionally may have been alkoxylated as described above.

Preferred alcohols are those of the general formula HO—(CH₂)ₓ—OH, where x is a number from 1 to 20, preferably an even number from 2 to 20. Preferred are ethylene glycol, butane-1,4-diol, hexane-1,6-diol, octane-1,8-diol and dodecane-1,12-diol. Additionally preferred is neopentyl glycol.

Also suitable are lactone-based polyester diols, which are homopolymers or copolymers of lactones, preferably hydroxy-terminated adducts of lactones with suitable difunctional starter molecules. Suitable lactones are preferably those which derive from compounds of the general formula HO—(CH₂)_{z}—COOH, where z is a number from 1 to 20 and where one H atom of a methylene unit may also have been substituted by a C₁ to C₄ alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Examples of suitable starter components include the low molecular mass dihydric alcohols specified above as a synthesis component for the polyester polyols. The corresponding polymers of ε-caprolactone are particularly preferred. Lower polyester diols or polyether diols as well can be used as starters for preparing the lactone polymers. In lieu of the polymers of lactones it is also possible to use the corresponding, chemically equivalent polycondensates of the hydroxycarboxylic acids corresponding to the lactones.

The functionality of the polyesterols corresponds in general to the number of head groups to be attached to the spacer.

The hydrocarbons may be, for example, polyisobutenes or polyolefin waxes which have been modified with reactive groups in such a way that they can be bound chemically to the head groups.

The skilled worker is aware that isobutene can be cationically polymerized or oligomerized with different catalyst systems to give polyisobutenes. Species which have acquired significance in practice include, in particular, BF₃ and AlCl₃, and also TiCl₄ and BCl₃, with TiCl₄ and BCl₃ being used in what is called “living cationic polymerization”.

Details relating to polymerization with BF₃ and AlCl₃ are found, for example, in “Ullmann's Encyclopedia of Industrial Chemistry”, Vol. A21, 555-561 (1992), and in “Cationic Polymerizations”, Marcel Dekker Inc. 1996, 685 ff., and also in the literature cited therein.

Using TiCl₄ and BCl₃, isobutene can be subjected to controlled cationic polymerization or oligomerization under defined conditions. This procedure is referred to in the literature as “living cationic polymerization” (on this point see, for example, Kennedy and Ivan, Designed Polymers by Carbocationic Macromolecular Engineering, Hanser Publishers (1992) and the literature cited therein). Detailed information is also found in WO-A1 01/10969, particularly page 8 line 23 to page 11 line 23 therein.

Both cationic polymerization with BF₃ and living cationic polymerization produce highly reactive polyisobutenes in the sense of this invention. Highly reactive polyisobutene in accordance with the invention means a polyisobutene with at least 60 mol % of end groups composed of vinyl isomer (β-olefin, —[—CH═C(CH₃)₂]) and/or vinylidene isomer (α-olefin, —[—C(CH₃)═CH₂]) or of corresponding precursors, such as —[—CH₂—C(CH₃)₂Cl], for example (determined via NMR spectroscopy).

Depending on the preparation of the polyisobutenes, the molecular weight distribution M_{w}/Mₙ is situated in a range of 1.05-10, with polymers from the “living” polymerization usually having values of between 1.05 and 2.0. Depending on the intended use, low (such as 1.1-1.5, for example, preferably around 1.3), medium (such as 1.6-2.0, for example, preferably around 1.8) or high (such as 2.5-10, for example, preferably 3-5) values may be of advantage.

For the method of the invention it is possible to employ polyisobutenes in a molecular weight range Mₙ from about 700 to about 100,000 daltons, with molecular weights of from about 1000 to 60,000 daltons being preferred. Particularly preferred polyisobutenes are those having an approximate number-average molecular weight Mₙ of 1500-32,000 daltons, very preferably 2000-25,000 and more particularly of 2300-18,000 daltons.

Polyolefin waxes, and among them more particularly polyethylene waxes, are already long established. They are substantially linear hydrophobic polymers which usually carry no functional groups. Functionalization of such polyolefin waxes, however, is necessary in order to allow attachment of the head groups.

Functionalization can be accomplished, for example, through copolymerization of a comonomer which carries a corresponding functional group, or through subsequent modification of the polyolefin waxes, as for example by graft polymerization with monomers that carry functional groups.

The number-average molecular weight Mₙ of the polyolefin waxes that can be used in accordance with the invention is up to 20,000, preferably up to 18,000, and more preferably up to 15,000 g/mol.

The polyolefin waxes can be prepared in stirred high-pressure autoclaves or in high-pressure tube reactors. Their preparation in stirred high-pressure autoclaves is preferred. The stirred high-pressure autoclaves employed for the purpose are known per se; a description is found in Ullmann's Encyclopedia of Industrial Chemistry, 5^{th} edition, entry headings: Waxes, Vol. A 28, p. 146 ff., Verlag Chemie Weinheim, Basle, Cambridge, New York, Tokyo, 1996.

The polyurethane polyols that can be used as spacers are generally reaction products of diisocyanates or polyisocyanates, preferably diisocyanates, with diols or polyols, the reaction being carried out in such a way that the products have the desired length and functionality.

The diisocyanates used may be aromatic, aliphatic or cycloaliphatic, preferably aliphatic or cycloaliphatic, referred to for short in this specification as (cyclo)aliphatic; aliphatic isocyanates are particularly preferred.

Aromatic isocyanates are those which comprise at least one aromatic ring system, in other words not only purely aromatic compounds but also araliphatic compounds.

Cycloaliphatic isocyanates are those which comprise at least one cycloaliphatic ring system.

Aliphatic isocyanates are those which comprise exclusively linear or branched chains, i.e., acyclic compounds.

In principle, higher isocyanates having on average more than 2 isocyanate groups are also contemplated. Suitability therefor is possessed for example by triisocyanates such as triisocyanatononane, 2,4,6-triisocyanatotoluene, triphenylmethane triisocyanate or 2,4,4′-triisocyanatodiphenyl ether, or the mixtures of diisocyanates, triisocyanates, and higher polyisocyanates that are obtained, for example, by phosgenation of corresponding aniline/formaldehyde condensates and represent methylene-bridged polyphenyl polyisocyanates.

These monomeric isocyanates do not contain any substantial products of reaction of the isocyanate groups with themselves.

The monomeric isocyanates are preferably isocyanates having 4 to 20 C atoms. Examples of typical diisocyanates are aliphatic diisocyanates such as tetramethylene diisocyanate, pentamethylene 1,5-diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethy1-5-(isocyanato-methyl)cyclohexane (isophorone diisocyanate), 1,3- or 1,4-bis(isocyanatomethyl)cyclo-hexane or 2,4-, or 2,6-diisocyanato-1-methylcyclohexane, and also 3 (or 4), 8 (or 9)-bis(isocyanatomethyl)tricyclo[5.2.1.0^{2,6}]decane isomer mixtures, and also aromatic diisocyanates such as tolylene 2,4- or 2,6-diisocyanate and the isomer mixtures thereof, m- or p-xylylene diisocyanate, 2,4′- or 4,4′-diisocyanatodiphenylmethane and the isomer mixtures thereof, phenylene 1,3- or 1,4-diisocyanate, 1-chlorophenylene 2,4-diisocyanate, naphthylene 1,5-diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Particular preference is given to hexamethylene 1,6-diisocyanate, 1,3-bis(isocyanato-methyl)cyclohexane, isophorone diisocyanate, and 4,4′- or 2,4′-di(isocyanato-cyclohexyl)methane, very particular preference to isophorone diisocyanate and hexamethylene 1,6-diisocyanate, and especial preference to hexamethylene 1,6-diisocyanate.

Mixtures of said isocyanates may also be present.

Isophorone diisocyanate is usually in the form of a mixture, specifically a mixture of the cis and trans isomers, generally in a proportion of about 60:40 to 80:20 (w/w), preferably in a proportion of about 70:30 to 75:25, and more preferably in a proportion of about 75:25.

Dicyclohexylmethane 4,4′-diisocyanate may likewise be in the form of a mixture of the different cis and trans isomers.

The polyisocyanates which can be formed by oligomerizing the monomeric isocyanates are generally characterized as follows:

The average NCO functionality of such compounds is in general at least 1.8 and can be up to 8, preferably 2 to 5, and more preferably 2.4 to 4.

The isocyanate group content after oligomerization, calculated as NCO=42 g/mol, is generally from 5% to 25% by weight unless otherwise specified.

The polyisocyanates are preferably compounds as follows:

1) Polyisocyanates containing isocyanurate groups and derived from aromatic, aliphatic and/or cycloaliphatic diisocyanates. Particular preference is given in this context to the corresponding aliphatic and/or cycloaliphatic isocyanatoisocyanurates and in particular to those based on hexamethylene diisocyanate and isophorone diisocyanate. The isocyanurates present are, in particular, trisisocyanatoalkyl and/or trisisocyanatocycloalkyl isocyanurates, which constitute cyclic trimers of the diisocyanates, or are mixtures with their higher homologs containing more than one isocyanurate ring. The isocyanatoisocyanurates generally have an NCO content of 10% to 30% by weight, in particular 15% to 25% by weight, and an average NCO functionality of 2.6 to 8.

2) Polyisocyanates containing uretdione groups and having aromatically, aliphatically and/or cycloaliphatically attached isocyanate groups, preferably aliphatically and/or cycloaliphatically attached, and in particular those derived from hexamethylene diisocyanate or isophorone diisocyanate. Uretdione diisocyanates are cyclic dimerization products of diisocyanates. The polyisocyanates containing uretdione groups are obtained in the context of this invention in a mixture with other polyisocyanates, more particularly those specified under 1). For this purpose the diisocyanates can be reacted under reaction conditions under which not only uretdione groups but also the other polyisocyanates are formed, or the uretdione groups are formed first of all and are subsequently reacted to give the other polyisocyanates, or the diisocyanates are first reacted to give the other polyisocyanates, which are subsequently reacted to give products containing uretdione groups.

3) Polyisocyanates containing biuret groups and having aromatically, cycloaliphatically or aliphatically attached, preferably cycloaliphatically or aliphatically attached, isocyanate groups, especially tris(6-isocyanatohexyl)biuret or its mixtures with its higher homologs. These polyisocyanates containing biuret groups generally have an NCO content of 18% to 22% by weight and an average NCO functionality of 2.8 to 6.

4) Polyisocyanates containing urethane and/or allophanate groups and having aromatically, aliphatically or cycloaliphatically attached, preferably aliphatically or cycloaliphatically attached, isocyanate groups, such as may be obtained, for example, by reacting excess amounts of diisocyanate, such as of hexamethylene diisocyanate or of isophorone diisocyanate, with mono- or polyhydric alcohols. These polyisocyanates containing urethane and/or allophanate groups generally have an NCO content of 12% to 24% by weight and an average NCO functionality of 2.5 to 4.5. Polyisocyanates of this kind containing urethane and/or allophanate groups may be prepared without catalyst or, preferably, in the presence of catalysts, such as ammonium carboxylates or ammonium hydroxides, for example, or allophanatization catalysts, such as Zn(II) compounds, for example, in each case in the presence of monohydric, dihydric or polyhydric, preferably monohydric, alcohols.

5) Polyisocyanates comprising oxadiazinetrione groups, derived preferably from hexamethylene diisocyanate or isophorone diisocyanate. Polyisocyanates of this kind comprising oxadiazinetrione groups are accessible from diisocyanate and carbon dioxide.

6) Polyisocyanates comprising iminooxadiazinedione groups, derived preferably from hexamethylene diisocyanate or isophorone diisocyanate. Polyisocyanates of this kind comprising iminooxadiazinedione groups are preparable from diisocyanates by means of specific catalysts.

7) Uretonimine-modified polyisocyanates.

8) Carbodiimide-modified polyisocyanates.

9) Hyperbranched polyisocyanates, of the kind known for example from EP-A 1134246, EP-A 1134247, EP-A 1167413, and EP-A 1026185.

10) Polyurethane-polyisocyanate prepolymers, from di- and/or polyisocyanates with alcohols.

11) Polyurea-polyisocyanate prepolymers.

12) The polyisocyanates 1)-11), preferably 1), 3), 4), and 6), can be converted, following their preparation, into polyisocyanates containing biuret groups or urethane/allophanate groups and having aromatically, cycloaliphatically or aliphatically attached, preferably (cyclo)aliphatically attached, isocyanate groups. The formation of biuret groups, for example, is accomplished by addition of water or by reaction with amines. The formation of urethane and/or allophanate groups is accomplished by reaction with monohydric, dihydric or polyhydric, preferably monohydric, alcohols, in the presence optionally of suitable catalysts. These polyisocyanates containing biuret or urethane/allophanate groups generally have an NCO content of 18% to 22% by weight and an average NCO functionality of 2.8 to 6.

13) Hydrophilically modified polyisocyanates, i.e., polyisocyanates which as well as the groups described under 1-12 also comprise groups which result formally from addition of molecules containing NCO-reactive groups and hydrophilizing groups to the isocyanate groups of the above molecules. The latter groups are nonionic groups such as alkylpolyethylene oxide and/or ionic groups derived from phosphoric acid, phosphonic acid, sulfuric acid or sulfonic acid, and/or their salts.

14) Modified polyisocyanates for dual cure applications, i.e., polyisocyanates which as well as the groups described under 1-12 also comprise groups resulting formally from addition of molecules containing NCO-reactive groups and UV-crosslinkable or actinic-radiation-crosslinkable groups to the isocyanate groups of the above molecules. These molecules are, for example, hydroxyalkyl (meth)acrylates and other hydroxy-vinyl compounds.

In one preferred embodiment of the present invention the polyisocyanate is selected from the group consisting of isocyanurates, biurets, urethanes, and allophanates, preferably from the group consisting of isocyanurates, urethanes, and allophanates, very preferably from the group consisting of isocyanurates and allophanates; more preferably it is a polyisocyanate containing isocyanurate groups.

In one particularly preferred embodiment the polyisocyanate encompasses polyisocyanates comprising isocyanurate groups and obtained from 1,6-hexamethylene diisocyanate.

In one further particularly preferred embodiment the polyisocyanate encompasses a mixture of polyisocyanates comprising isocyanurate groups and obtained from 1,6-hexamethylene diisocyanate and from isophorone diisocyanate.

Diols or polyols contemplated for the preparation of polyurethane polyols as spacers include, for example, the abovementioned polyetherols or polyesterols, but preferably 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, polyTHF having a molar mass of between 162 and 4500, preferably 250 to 2000, poly-1,3-propanediol having a molar mass of between 134 and 1178, poly-1,2-propanediol having a molar mass of between 134 and 898, polyethylene glycol having a molar mass of between 106 and 458, neopentylglycol, neopentylglycol hydroxypivalate, 2-ethyl-1,3-propanediol, 2-methyl-1,3-propanediol, 2,2-bis(4-hydroxycyclohexyl)propane, 1,1-, 1,2-, 1,3-, and 1,4-cyclohexanedimethanol, 1,2-, 1,3- or 1,4-cyclohexanediol, trimethylolbutane, trimethylolpropane, trimethylolethane, neopentylglycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which if desired may be alkoxylated as described above, particular preference among these diols and polyols being given to the aliphatic compounds, and among them very particular preference to the diols.

One way of preparing the crosslinkers of the invention is to react one or more of the above-recited spacers, selected from the group consisting of polyethers, polyesters, polycarbonates, hydrocarbons, and polyurethane polyols, with at least one polyisocyanate as head group in such a way as to give a crosslinker having the characteristics of the invention.

Polyisocyanates suitable for this purpose are, for example, the polyisocyanates 1) to 14) recited above under the polyurethane polyols, and among them preferably polyisocyanates 1) containing isocyanurate groups, and/or hyperbranched polyisocyanates 9), more preferably those polyisocyanates formed from 1,6-hexamethylene diisocyanate and/or isophorone diisocyanate.

The polyisocyanates are connected to the spacer preferably by way of urethane, allophanate, urea or biuret groups or their analogous thio compounds, preferably via urethane groups and/or allophanate groups. Mixtures in terms of the linking are also possible.

One preferred embodiment of the present invention is represented by crosslinkers (A) whose head groups have a high functionality density of at least 2.5 mol/kg, in other words at least 2.5 mol of functional groups per kg of the head groups, considered in isolation, prior to linking with the spacer, more preferably at least 3 mol/kg, very preferably at least 4.5 mol/kg, and more particularly at least 5 mol/kg. The functionality density of the head groups can be up to 10 mol/kg, preferably up to 8 and more preferably up to 7 mol/kg.

The present invention further provides for the use of crosslinkers (A) in coating compositions for simultaneously increasing hardness and flexibility and/or high scratch resistance of the coatings formed from them.

Additionally provided by the present invention is a method of simultaneously increasing hardness and flexibility and/or scratch resistance of coatings by admixing the coating compositions from which the coatings are obtained with at least one crosslinker (A). Generally speaking, it is sufficient to replace at least 3% by weight, based on the total amount of crosslinker, by the crosslinker (A) of the invention, preferably at least 5% by weight. Usually there is no need for more than 30% by weight, preferably up to 20% and more preferably up to 15% by weight.

The simultaneous increase in hardness and flexibility and/or scratch resistance is preferably determined by preparing one coating composition with conventional crosslinker, in other words a crosslinker other than the crosslinkers (A) of the invention, and binder (B) with the same type of functional groups FG and identical binder. 30 mol % of the conventional crosslinker, based on the functional groups FG, is replaced by the crosslinker (A) of the invention, and curing takes place under comparable conditions. On both cured coatings, then, as a measure of the hardness, measurements are made of the pendulum damping to DIN 53157, the Erichsen cupping in accordance with DIN 53156, and the scratch resistance.

With regard to pendulum damping, high values denote high hardness. An increase in pendulum damping by at least 5% implies a significant increase in the hardness.

With regard to Erichsen cupping, high values denote high flexibility. An increase in Erichsen cupping by at least 10% implies a significant increase in the flexibility.

The scratch resistance is determined preferably as follows: a fitter's hammer weighing 500 g had a fiber web (Scotchbrite®, 7448 type S ultrafine) attached to its head using double-sided adhesive tape. The hammer was held by two fingers at the shaft end, and was moved back and forth over the coating film with uniform strokes, without tipping and without additional application of force, in a line. After 50 back-and-forth strokes, followed by heat treatment for 60 minutes in a forced-air oven at 60° C. (reflow) and storage for 4 h at 23° C. and 50% relative humidity, a determination was made of the gloss transverse to the direction of abrasion. The fiber web was replaced by a new web after each test.

The glass was measured using a Mikro TRI-Gloss gloss meter at 20° and/or 60° incident angle.

An increase in scratch resistance by 10% in the gloss after 50 strokes implies a significant increase.

The binder (B) is guided by the selection of the crosslinker (A) and has reactive groups that are complementary to the groups FG.

The binders (B) have a functionality of at least 2, preferably at least 3, more preferably at least 4, and very preferably at least 6. There is no upper limit on the functionality, which may be preferably up to 100, more preferably up to 75, and very preferably up to 50.

The number-average molecular weight Mr, of the binders (B) is usually at least 1000, more preferably at least 2000, and very preferably at least 5000 g/mol. The molecular weight Mₙ may amount, for example, to up to 200,000, preferably up to 100,000, more preferably up to 80,000, and very preferably up to 50,000 g/mol. In individual cases the molecular weights may also be higher still.

In the preferred case of isocyanate groups as groups FG, the binders are, for example, polyacrylate polyols, polyester polyols, polyether polyols, polyurethane polyols; polyurea polyols; polyester-polyacrylate polyols; polyester-polyurethane polyols; polyurethane-polyacrylate polyols, polyurethane-modified alkyd resins; fatty acid-modified polyester-polyurethane polyols, copolymers with allyl ethers, graft polymers of the stated groups of compounds, having, for example, different glass transition temperatures, and also mixtures of the stated binders. Preference is given to polyacrylate polyols, polyester polyols, and polyether polyols.

Preferred binder OH numbers, measured in accordance with DIN 53240-2, are 40-350 mg KOH/g resin solids for polyesters, preferably 80-180 mg KOH/g resin solids, and 15-250 mg KOH/g resin solids for polyacrylateols, preferably 80-160 mg KOH/g.

Additionally the binders may have an acid number in accordance with DIN EN ISO 3682 of up to 200 mg KOH/g, preferably up to 150 and more preferably up to 100 mg KOH/g.

Polyacrylate polyol binders preferably have a molecular weight Mₙ of at least 1000, more preferably at least 2000, and very preferably at least 5000 g/mol. The molecular weight Mₙ may in principle have no upper limit, and may preferably be up to 200,000 g/mol, more preferably up to 100,000 g/mol, very preferably up to 80,000 g/mol, and more particularly up to 50,000 g/mol.

Hydroxyl groups are introduced into the polyacrylate polyols by copolymerizing polymerizable monomers with hydroxy-functional monomers. The latter may be, for example, monoesters of α,β-unsaturated carboxylic acids, such as acrylic acid, methacrylic acid (identified for short in this specification as “(meth)acrylic acid”), with diols or polyols which have preferably 2 to 20 C atoms and at least two hydroxyl groups, such as ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,4-butanediol, 1,5-pentanediol, neopentyl glycol, neopentyl glycol hydroxypivalate, 2-ethyl-1,3-propanediol, 2-methyl-1,3-propanediol, 2-butyl-2-ethyl-1,3-propanediol, 1,6-hexanediol, 2-methyl-1,5-pentanediol, 2-ethyl-1,4-butanediol, 2-ethyl-1,3-hexanediol, 2,4-diethyloctane-1,3-diol, 2,2-bis(4-hydroxycyclohexyl)propane, 1,1-, 1,2-, 1,3- and 1,4-bis(hydroxymethyl)cyclohexane, 1,2-, 1,3- or 1,4-cyclohexanediol, glycerol, trimethylolethane, trimethylolpropane, trimethylolbutane, pentaerythritol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, isomalt, polyTHF with a molar weight between 162 and 4500, preferably 250 to 2000, poly-1,3-propanediol or polypropylene glycol with a molar weight between 134 and 2000, or polyethylene glycol with a molar weight between 238 and 2000.

Preference is given to 2-hydroxyethyl acrylate, 2-hydroxyethyl methacrylate, 2- or 3-hydroxypropyl (meth)acrylate, 1,4-butanediol monoacrylate or 3-(acryloyloxy)-2-hydroxypropyl acrylate, and particular preference to 2-hydroxyethyl acrylate and/or 2-hydroxyethyl methacrylate.

The hydroxyl-bearing monomers are used in the copolymerization in a mixture with other polymerizable monomers, preferably free-radically polymerizable monomers, preferably those composed to an extent of at least 10%, more preferably at least 25%, and very preferably at least 50% by weight of C₁-C₂₀, preferably C₁ to C₄ alkyl (meth)acrylate, (meth)acrylic acid, vinylaromatics having up to 20 C atoms, vinyl esters of carboxylic acids comprising up to 20 C atoms, vinyl halides, nonaromatic hydrocarbons having 4 to 8 C atoms and 1 or 2 double bonds, unsaturated nitriles, and mixtures thereof. Particular preference is given to the polymers composed—besides the hydroxyl-bearing monomers—to an extent of more than 60% by weight of C₁-C₁₀ alkyl (meth)acrylates, styrene and its derivatives, vinylimidazole or mixtures thereof.

Additionally the polymers may comprise hydroxy-functional monomers in accordance with the above hydroxyl group content, and, if desired, further monomers, examples being (meth)acrylic acid glycidyl epoxy esters, ethylenically unsaturated acids, more particularly carboxylic acids, acid anhydrides or acid amides.

Further binders (B) are, for example, polyesterols, as are obtainable by condensing polycarboxylic acids, especially dicarboxylic acids, with polyols, especially diols. In order to ensure a polyester polyol functionality that is appropriate for the polymerization, use is also made in part of triols, tetrols, etc, and also triacids, etc.

Polyester polyols are known for example from Ullmanns Encyklopädie der technischen Chemie, 4th edition, volume 19, pp. 62 to 65. It is preferred to use polyester polyols which are obtained by reacting dihydric alcohols with dibasic carboxylic acids. In lieu of the free polycarboxylic acids it is also possible to use the corresponding polycarboxylic anhydrides or corresponding polycarboxylic esters of lower alcohols or mixtures thereof to prepare the polyester polyols. The polycarboxylic acids may be aliphatic, cycloaliphatic, aromatic or heterocyclic and may if appropriate be substituted, by halogen atoms for example, and/or unsaturated. Examples thereof that may be mentioned include the following:

Oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, C₁-C₄ alkyl esters for example, preferably methyl, ethyl or n-butyl esters, of the stated acids are employed. Preference is given to dicarboxylic acids of the general formula HOOC—(CH₂)_{y}—COOH, where y is a number from 1 to 20, preferably an even number from 2 to 20, and more preferably succinic acid, adipic acid, sebacic acid, and dodecanedicarboxylic acid.

Suitable polyhydric alcohols for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, PolyTHF having a molar mass of between 162 and 4500, preferably 250 to 2000, poly-1,3-propanediol having a molar mass between 134 and 1178, poly-1,2-propanediol having a molar mass between 134 and 898, polyethylene glycol having a molar mass between 106 and 458, neopentyl glycol, neopentyl glycol hydroxypivalate, 2-ethyl-1,3-propanediol, 2-methyl-1,3-propanediol, 2,2-bis(4-hydroxycyclohexyl)propane, 1,1-, 1,2-, 1,3- and 1,4-cyclohexanedimethanol, 1,2-, 1,3- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which if desired may have been alkoxylated as described above.

Preferred alcohols are those of the general formula HO—(CH₂)ₓ—OH, where x is a number from 1 to 20, preferably an even number from 2 to 20. Preferred are ethylene glycol, butane-1,4-diol, hexane-1,6-diol, octane-1,8-diol and dodecane-1,12-diol. Additionally preferred is neopentyl glycol.

Also suitable, furthermore, as binders (B) are polycarbonate diols of the kind obtainable, for example, by reacting phosgene with an excess of the low molecular mass alcohols specified as synthesis components for the polyester polyols.

Also suitable are lactone-based polyester diols, which are homopolymers or copolymers of lactones, preferably hydroxy-terminated adducts of lactones with suitable difunctional starter molecules. Suitable lactones are preferably those which derive from compounds of the general formula HO—(CH₂)_{z}—COOH, where z is a number from 1 to 20 and where one H atom of a methylene unit may also have been substituted by a C₁ to C₄ alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Examples of suitable starter components include the low molecular mass dihydric alcohols specified above as a synthesis component for the polyester polyols. The corresponding polymers of ε-caprolactone are particularly preferred. Lower polyester diols or polyether diols as well can be used as starters for preparing the lactone polymers. In lieu of the polymers of lactones it is also possible to use the corresponding, chemically equivalent polycondensates of the hydroxycarboxylic acids corresponding to the lactones.

Additionally suitable as binders are polyetherols, which are prepared by addition of ethylene oxide, propylene oxide or butylene oxide to H-active components. Polycondensates of butanediol are also suitable.

Additionally it is possible to use hydroxy-functional carboxylic acids, such as dimethylolpropionic acid or dimethylolbutanoic acid, for example.

The polymers may of course also be compounds having primary or secondary amino groups.

In the coating composition, crosslinker (A) and binder (B) are mixed in a stoichiometric ratio of, for example, 5:1 to 1:5, preferably 3:1 to 1:3, more preferably 2:1 to 1:2, very preferably 1.5:1 to 1:1.5, and more particularly 1.1:1 to 1:1.2.

If necessary, the coating composition may also be admixed with a solvent (C) and/or further, typical coatings additives (D).

Examples of solvents (C) are esters, ester alcohols, ethers, ether alcohols, aromatic and/or (cyclo)aliphatic hydrocarbons, and mixtures thereof, and also halogenated hydrocarbons. Via the amino resins it is also possible to introduce alcohol into the mixtures as well.

Preference is given to alkanoic acid alkyl esters, alkanoic acid alkyl ester ethers, alkoxylated alkanoic acid alkyl esters, and mixtures thereof.

Esters are, for example, n-butyl acetate, ethyl acetate, 1-methoxyprop-2-yl acetate, and 2-methoxyethyl acetate, and also the monoacetyl and diacetyl esters of ethylene glycol, diethylene glycol, triethylene glycol, propylene glycol, dipropylene glycol or tripropylene glycol, such as butylglycol acetate, for example. Other examples include carbonates as well, such as, preferably 1,2-ethylene carbonate, 1,2-propylene carbonate or 1,3-propylene carbonate.

Ethers are, for example, tetrahydrofuran (THF), dioxane, and also the dimethyl, diethyl or di-n-butyl ethers of ethylene glycol, diethylene glycol, triethylene glycol, propylene glycol, dipropylene glycol or tripropylene glycol.

Alkanoic acid ester ethers are, for example, poly(C₂ to C₃) alkylene glycol (C₁ to C₄)monoalkyl ether acetates.

Ether alcohols are, for example, poly(C₂ to C₃) alkylene glycol di(C₁ to C₄)alkyl ethers, dipropylene glycol dimethyl ether, preferably butyl glycol dialkyl ethers.

Aromatic hydrocarbon mixtures are those which comprise predominantly aromatic C₇ to C₁₄ hydrocarbons and may comprise a boiling range from 110 to 300° C.; particular preference is given to toluene, o-, m- or p-xylene, trimethylbenzene isomers, tetramethylbenzene isomers, ethylbenzene, cumene, tetrahydronaphthalene, and mixtures comprising them.

Examples thereof are the Solvesso® products from ExxonMobil Chemical, especially Solvesso® 100 (CAS No. 64742-95-6, predominantly C₉ and C₁₀ aromatics, boiling range about 154-178° C.), 150 (boiling range about 182-207° C.), and 200 (CAS No. 64742-94-5), and also the Shellsol® products from Shell, Caromax® (e.g., Caromax® 18) from Petrochem Carless and products from DHC (e.g., Hydrosol® A 170). Hydrocarbon mixtures comprising paraffins, cycloparaffins, and aromatics are also available commercially under the names Kristalloel (for example, Kristalloel 30, boiling range about 158-198° C. or Kristalloel 60: CAS No. 64742-82-1), white spirit (for example likewise CAS No. 64742-82-1) or solvent naphtha (light: boiling range about 155-180° C., heavy: boiling range about 225-300° C.). The aromatics content of such hydrocarbon mixtures is generally more than 90%, preferably more than 95%, more preferably more than 98%, and very preferably more than 99% by weight. It may be advisable to use hydrocarbon mixtures having a particularly reduced naphthalene content.

The density of the hydrocarbons to DIN 51757 at 20° C. may be less than 1 g/cm³, preferably less then 0.95, and more preferably less than 0.9 g/cm³.

The amount of aliphatic hydrocarbons is generally less than 5%, preferably less than 2.5%, and more preferably less than 1% by weight.

Examples of (cyclo)aliphatic hydrocarbons include decalin, alkylated decalin, and isomer mixtures of linear or branched alkanes and/or cycloalkanes.

Preferred are n-butyl acetate, ethyl acetate, 1-methoxyprop-2-yl acetate, 2-methoxyethyl acetate, and mixtures thereof.

Mixtures of this kind may be produced in a volume ratio of 10:1 to 1:10, preferably in a volume ratio of 5:1 to 1:5, and more preferably in a volume ratio of 1:1, figures do not include any solvent that may still be present in the transetherification reaction mixture, and particularly the alcohols R¹OH and R²OH.

Preferred examples are butyl acetate/xylene, 1:1 methoxypropyl acetate/xylene, 1:1 butyl acetate/Solvent naphtha 100, 1:2 butyl acetate/Solvesso® 100, and 3:1 Kristallöl 30/Shellsol® A.

Examples of possible further, typical coatings additives (D) include antioxidants, stabilizers, activators (accelerants), fillers, pigments, dyes, antistats, flame retardants, thickeners, thixotropic agents, surface-active agents, viscosity modifiers, plasticizers or chelating agents.

Suitable thickeners include, in addition to free-radically (co)polymerized (co)polymers, typical organic and inorganic thickeners such as hydroxymethylcellulose or bentonite.

Chelating agents which can be used include, for example, ethylenediaminacetic acid and salts thereof and also β-diketones.

Suitable fillers comprise silicates, examples being silicates obtainable by silicon tetrachloride hydrolysis, such as Aerosil® from Degussa, siliceous earth, talc, aluminum silicates, magnesium silicates, calcium carbonates, etc.

Suitable stabilizers comprise typical UV absorbers such as oxanilides, triazines, and benzotriazole (the latter available as Tinuvin® grades from Ciba-Spezialitätenchemie), and benzophenones. They can be used alone or together with suitable free-radical scavengers, examples being sterically hindered amines such as 2,2,6,6-tetramethylpiperidine, 2,6-di-tert-butylpiperidine or derivatives thereof, e.g., bis(2,2,6,6-tetramethyl-4-piperidyl) sebacate. Stabilizers are used typically in amounts of 0.1% to 5.0% by weight, based on the solid components present in the formulation.

Pigments may likewise be present. Pigments are, according to CD Römpp Chemie Lexikon—Version 1.0, Stuttgart/New York: Georg Thieme Verlag 1995, with reference to DIN 55943, particulate “colorants that are organic or inorganic, chromatic or achromatic and are virtually insoluble in the application medium”.

Virtually insoluble here means a solubility at 25° C. below 1 g/1000 g application medium, preferably below 0.5, more preferably below 0.25, very particularly preferably below 0.1, and in particular below 0.05 g/1000 g application medium.

Examples of pigments comprise any desired systems of absorption pigments and/or effect pigments, preferably absorption pigments. There are no restrictions whatsoever on the number and selection of the pigment components. They may be adapted as desired to the particular requirements, such as the desired perceived color, for example.

Effect pigments are all pigments which exhibit a platelet-shaped construction and give a surface coating specific decorative color effects. The effect pigments are, for example, all of the pigments which impart effect and can be used typically in vehicle finishing and industrial coatings. Examples of such effect pigments are pure metallic pigments, such as aluminum, iron or copper pigments; interference pigments, such as titanium dioxide-coated mica, iron oxide-coated mica, mixed okde-coated mica (e.g., with titanium dioxide and Fe₂O₃ or titanium dioxide and Cr₂O₃), metal oxide-coated aluminum; or liquid-crystal pigments, for example.

The coloring absorption pigments are, for example, typical organic or inorganic absorption pigments that can be used in the coatings industry. Examples of organic absorption pigments are azo pigments, phthalocyanine pigments, quinacridone pigments, and pyrrolopyrrole pigments. Examples of inorganic absorption pigments are iron oxide pigments, titanium dioxide, and carbon black.

The coating compositions of the invention are suitable for coating substrates such as wood, paper, textile, leather, nonwoven, plastics surfaces, glass, ceramic, mineral building materials, such as molded cement blocks and fiber cement slabs, or coated or uncoated metals, preferably plastics or metals, more particularly in the form of films, foils or sheets, with particular preference metals.

The coating compositions of the invention are suitable as or in interior coatings, or else preferably as or in exterior coatings, in other words in those applications where there is exposure to daylight, on parts of buildings, coatings on vehicles and aircraft, and for industrial applications. More particularly the coating compositions of the invention are used as or in automotive clearcoat, basecoat, and topcoat material(s) or primers. Other preferred fields of use are can coating and coil coating.

In particular they are suitable as primers, primer-surfacers, pigmented topcoat materials and clearcoat (or transparent coating) materials in the segments of industrial coating, wood coating, automotive finishing, more particularly OEM finishing, or decorative coating. The coating compositions are especially suitable for applications requiring particularly high application reliability, outdoor weathering resistance, optical qualities, scratch resistance, solvent resistance and/or chemical resistance.

The substrates are coated with the coating compositions of the invention by typical methods known to the skilled worker, with at least one coating composition of the invention or a film-forming formulation being applied in the desired thickness to the substrate to be coated, and the volatile constituents of the coating compositions being removed, if desired with heating (drying). This operation may if desired be repeated one or more times. Application to the substrate may take place in a known way, as for example by spraying, trowelling, knifecoating, brushing, rolling, roller coating, or flow coating. The coating thickness is situated generally in a range from about 3 to 1000 g/m² and preferably 10 to 200 g/m².

This may be followed by curing.

Curing is generally accomplished by drying and/or curing—following application of the coating to the substrates—materials at a temperature of up to 140° C. if appropriate, preferably room temperature to 120° C. and more preferably room temperature to 100° C., over a period of up to 72 hours, preferably up to 48 hours, more preferably up to 24 hours, very preferably up to 12 hours and in particular up to 6 hours, under an oxygen-containing atmosphere, preferably air, or under inert gas. Curing of the coating material takes place as a function of the amount of coating material applied and of the crosslinking energy introduced via high-energy radiation, heat transfer from heated surfaces, or via convection of gaseous media, over a period of seconds, for example, in the case of coil coating in combination with NIR drying, up to 5 hours, for example, high-build systems on temperature-sensitive materials, usually not less than 10 minutes, preferably not less than 15, more preferably not less than 30, and very preferably not less than 45 minutes. Drying essentially comprises removal of existing solvent, and in addition there may also, even at this stage, be reaction with the binder, whereas curing essentially comprises reaction with the binder.

In addition to or instead of thermal curing, the curing may also take place by means of IR and NIR radiation, with NIR radiation here denoting electromagnetic radiation in the wavelength range from 760 nm to 2.5 μm, preferably from 900 to 1500 nm.

Curing takes place in a time of 1 second to 60 minutes, preferably of 1 minute to 45 minutes.

Examples of suitable substrates for the coating compositions of the invention include thermoplastic polymers, especially polymethyl methacrylates, polybutyl methacrylates, polyethylene terephthalates, polybutylene terephthalates, polyvinylidene fluorides, polyvinyl chlorides, polyesters, polyolefins, acrylonitrile-ethylenepropylene-diene-styrene copolymers (A-EPDM), polyetherimides, polyether ketones, polyphenylene sulfides, polyphenylene ethers or mixtures thereof.

Mention may further be made of polyethylene, polypropylene, polystyrene, polybutadiene, polyesters, polyamides, polyethers, polycarbonate, polyvinylacetal, polyacrylonitrile, polyacetal, polyvinyl alcohol, polyvinyl acetate, phenolic resins, urea resins, melamine resins, alkyd resins, epoxy resins or polyurethanes, block or graft copolymers thereof, and blends of these.

Mention may preferably be made of ABS, AES, AMMA, ASA, EP, EPS, EVA, EVAL, HDPE, LDPE, MABS, MBS, MF, PA, PA6, PA66, PAN, PB, PBT, PBTP, PC, PE, PEC, PEEK, PEI, PEK, PEP, PES, PET, PETP, PF, PI, FIB, PMMA, POM, PP, PPS, PS, PSU, PUR, PVAC, PVAL, PVC, PVDC, PVP, SAN, SB, SMS, UF, UP plastics (abbreviated names in accordance with DIN 7728) and aliphatic polyketones.

Particularly preferred substrates are polyolefins, such as, for example, PP (polypropylene), which optionally may be isotactic, syndiotactic or atactic and optionally may be unoriented or may have been oriented by uniaxial or biaxial stretching, SAN (styrene-acrylonitrile-copolymers), PC (polycarbonates), PVC (polyvinyl chlorides), PMMA (polymethyl methacrylates), PBT (poly(butylene terephthalate)s), PA (polyamides), ASA (acrylonitrile-styrene-acrylate copolymers) and ABS (acrylonitrile-butadiene-styrene-copolymers), and also their physical mixtures (blends). Particular preference is given to PP, SAN, ABS, ASA and blends of ABS or ASA with PA or PBT or PC. Especially preferred are polyolefins, PMMA and PVC.

Especially preferred is ASA, particularly in accordance with DE 196 51 350 and the ASA/PC blend. Preference is likewise given to polymethyl methacrylate (PMMA) or impact-modified PMMA.

A further-preferred substrate for coating with the coating materials of the invention are metals. The metals in question are especially those which have already been coated with another coating film, such as with an electrocoat, primer-surfacer, primer or basecoat. These coating films may be solvent-based, water-based or powder coating-based, may be crosslinked, part-crosslinked or thermoplastic, may have been cured through their volume or may have been applied wet-on-wet.

As far as the type of metal is concerned, suitable metals may in principle be any desired metals. In particular, however, they are metals or alloys which are typically employed as metallic materials of construction and require protection against corrosion.

The surfaces in question are in particular those of iron, steel, Zn, Zn alloys, Al or Al alloys. These may be the surfaces of structures composed entirely of the metals or alloys in question. Alternatively the structures may have been only coated with these metals and may themselves be composed of materials of other kinds, such as of other metals, alloys, polymers or composite materials, for example. They may be surfaces of castings made from galvanized iron or steel. In one preferred embodiment of the present invention the surfaces are steel surfaces.

Zn alloys or Al alloys are known to the skilled worker. The skilled worker selects the nature and amount of alloying constituents in accordance with the desired end-use application. Typical constituents of zinc alloys comprise, in particular, Al, Pb, Si, Mg, Sn, Cu or Cd. Typical constituents of aluminum alloys comprise, in particular, Mg, Mn, Si, Zn, Cr, Zr, Cu or Ti. The alloys may also be Al/Zn alloys in which Al and Zn are present in an approximately equal amount. Steel coated with alloys of these kinds is available commercially. The steel may comprise the typical alloying components known to the skilled worker.

Also conceivable is the use of the coating materials of the invention for treating tin-plated iron/steel (tinplate).

1-11. (canceled)

12. A coating composition comprising
at least one crosslinker (A)comprising a plurality of functional groups FG, and
at least one binder (B) comprising comprises at least two groups which are reactive toward the functional groups FG of the crosslinker (A), wherein
the functional groups FG are isocyanate groups (—NCO), and
the crosslinker further comprises
at least one spacer to which not more than 10% of all functional groups FG included in the crosslinker are bound, and
at least two head groups arranged terminally on the spacer,
at least 80% of the atoms and groups of atoms that form the spacer are constituents of acyclic structures
the spacer is substantially constructed of at least 50 atoms and groups of atoms which are joined to one another by single bonds and are in each case independently of one another selected from the group consisting of —CH₂—, —CHR³—, —CR³R⁴—, —C(═O)—, —O—, —NH—, and —NR³—, with not more than 10 bonds of the spacer being multiple bonds and/or part of a ring system with R³ and R⁴ independently of one another being C₁ to C₁₈ alkyl, C₆ to C₁₂ aryl or C₅ to C₁₂ cycloalkyl and the head groups
each carrying at least two functional groups FG, the density of functional groups FG in the crosslinker (A) being at least 2 mol/kg.

13. The coating composition according to claim 12, wherein the spacer comprises from 50 to 2000 atoms and groups of atoms.

14. The coating composition according to claim 12, wherein the number of functional groups FG on the head unit in the crosslinker (A) is from 2 to 10.

15. The coating composition according to claim 12, wherein the density of functional groups in the crosslinker (A) is from 3 to 6 mol/kg.

16. The coating composition according to claim 12, wherein the average number of head groups per crosslinker (A) is from 2 to 5.

17. The coating composition according to claim 12, wherein the spacer is derived from a polyTHF having a molar weight of between 700 and 4500.

18. The coating composition according to claim 12, wherein the head group is derived from a polyisocyanate comprising isocyanurate groups.

19. The coating composition according to claim 12, wherein the head group is derived from a hyperbranched polyisocyanate.

20. The coating composition according to claim 18, wherein the polyisocyanate is formed from 1,6-hexamethylene diisocyanate and/or isophorone diisocyanate.

21. A method of increasing hardness and flexibility and/or scratch resistance of a coating, which comprises admixing the coating composition from which the coating is obtained with at least one crosslinker (A) of claim 12.
